(19) United States
(12) Patent Application Publication
(10) Pub. No.: US 2020/0013260 A1
(43) Pub. Date: Jan. 9, 2020

(54) INFORMATION PROCESSOR

(71) Applicant: Universal Entertainment Corporation, Tokyo (JP)

(72) Inventors: Masaki OYAMA, Tokyo (JP); Toshikazu JINNOUCHI, Tokyo (JP)

(21) Appl. No.: 16/504,496

(22) Filed: Jul. 8, 2019

(30) Foreign Application Priority Data
Jul. 9, 2018 (JP) 2018-129898

(51) Int. Cl. G07F 17/32; G07F 17/34

(52) U.S. Cl. CPC G07F 17/3213; G07F 17/34

(57) ABSTRACT

An information processor, which runs a unit game in which reel strips on which symbols are arranged stop in a matrix-shaped symbol display area, includes a controller which is programmed to execute the processes of: (a) randomly determining the symbols which will stop in the symbol display area; (b) scrolling the reel strips and then stopping the symbols determined in the process (a) in the symbol display area; (c) when plural specific symbols are included in the symbols having stopped in the symbol display area, determining whether another symbol which is different from the specific symbol stops between the specific symbols; and (d) when it is determined in the process (c) that the another symbol stops between the stopped specific symbols, replacing the another symbol with the specific symbol.

### CROSS-REFERENCE TO RELATED APPLICATION

This application is entitled to the benefit of Japanese Patent Application No. 2018-129898 filed on Jul. 9, 2018.

### BACKGROUND OF THE INVENTION

### 1. Field of the Invention

The present invention relates to an information processor.

### 2. Description of Related Art

As a social game, there is a slot machine game in which random determination is performed in response to a player's operation of a touch panel of a smartphone, reel strips stop based on a result of the random determination, and a payout is awarded based on stopped symbols. In such a game, when a predetermined condition is satisfied, a reel strip may be replaced with another reel strip on which more symbols advantageous for the player (e.g., symbols with which a bonus or a high payout is awarded) are arranged, in order to provide an advantageous situation for the player.

For example, in Patent Literature 1 (U.S. Pat. No. 9,202,347), a free game video reel strip on which the number of character symbols advantageous for a player is larger than the number on a normal game video reel strip is used, when a predetermined condition is satisfied and shift from a normal game to a free game occurs.

### BRIEF SUMMARY OF THE INVENTION

However, when plural types of reel strips (e.g., a normal game video reel strip and a free game video reel strip) are prepared to provide an advantageous situation for the player as described above, the memory capacity is disadvantageously increased. Furthermore, when, in order to provide an advantageous situation for the player, a process of increasing the number of symbols advantageous for the player or changing some symbols to symbols advantageous for the player is executed while reel strips are scrolling, the system processes may become disadvantageously complicated.

The present disclosure therefore provides an information processor in which an effect of increasing the number of symbols advantageous for a player can be executed without increasing the required memory capacity, while the system of processes is less likely to become complicated.

An information processor of the present disclosure for solving the problem above, which runs a unit game in which reel strips on which symbols are arranged stop in a matrix-shaped symbol display area, includes a controller programmed to execute the processes of:
(a) randomly determining the symbols which will stop in the symbol display area;
(b) scrolling the reel strips and then stopping the symbols determined in the process (a) in the symbol display area;
(c) when plural specific symbols are included in the symbols having stopped in the symbol display area, determining whether another symbol which is different from the specific symbol stops between the specific symbols; and
(d) when it is determined in the process (c) that the another symbol stops between the stopped specific symbols, replacing the another symbol with the specific symbol.

According to the arrangement above, after the reel strips are stopped, only the another symbol sandwiched between the specific symbols is replaced with the specific symbol. On this account, it is unnecessary to prepare plural reel strips, and to execute a process of increasing the number of the specific symbols during the scroll. On this account, an effect of increasing the specific symbols can be executed without increasing the required capacity of the memory, while the system of processes is less likely to become complicated.

The information processor of the present disclosure is further arranged such that, in the step (d), a region including the another symbol and two of the specific symbols sandwiching the another symbol is specified as a video region where an image effect is possible, the image effect of replacing the another symbol with the specific symbol is performed in the video region, and the specific symbols are highlighted by changing brightness of the symbol display area.

According to the arrangement above, after the reel strips are stopped, only the another symbol sandwiched between the specific symbols is replaced with the specific symbol.

It is therefore possible to provide an information processor in which an effect of increasing the number of symbols advantageous for a player can be executed without increasing the required memory capacity, while the system of processes is less likely to become complicated.

### BRIEF DESCRIPTION OF THE DRAWINGS

Other and further objects, features and advantages of the invention will appear more fully from the following description taken in connection with the accompanying drawings in which:

FIG. 1 illustrates a network environment between a server and a smartphone.

FIG. 2 is a block diagram of the electrical configuration of the smartphone.

FIG. 3 shows a display state of a slot game on the smartphone.

FIG. 4 shows paylines of the slot game.

FIG. 5 illustrates symbol arrays of video reels in the slot game.

FIG. 6 illustrates a symbol combination table of the slot game.

FIG. 7 shows a flowchart of a normal slot game control process.

FIG. 8 shows a flowchart of a bet/start-check process.

FIG. 9 shows a flowchart of a symbol display control process of the normal slot game control process.

FIG. 10 shows a flowchart of a free game process.

FIG. 11 shows a flowchart of a FG symbol display control process of the free game process.

FIG. 12 illustrates the displayed slot game.

FIG. 13 illustrates the displayed slot game.

FIG. 14 illustrates the displayed slot game.

FIG. 15 illustrates the displayed slot game.

FIG. 16 illustrates the displayed slot game.

### DETAILED DESCRIPTION OF THE PREFERRED EMBODIMENT

### Embodiment

The following will describe an information processor of an embodiment of the present invention with reference to figures.

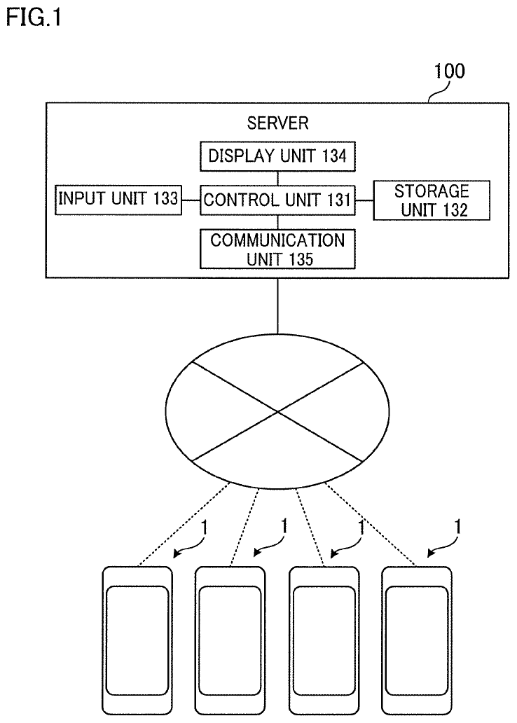

A slot game (unit game) which is run in the present embodiment is embodied as a social game by a server 100 (information processor) shown in FIG. 1. To be more specific, game software of the slot game is run on a web browser provided by the server 100. As a result of player's access to the web browser provided by the server 100 through an information device such as a smartphone 1 and a PC, the slot game is run.

In the present embodiment, the server 100 shown in FIG. 1 is taken as an example of the information processor. While the descriptions below deal with the server 100, processes and operations of the server 100 can be interpreted as those of a program or a game control method.

### Online

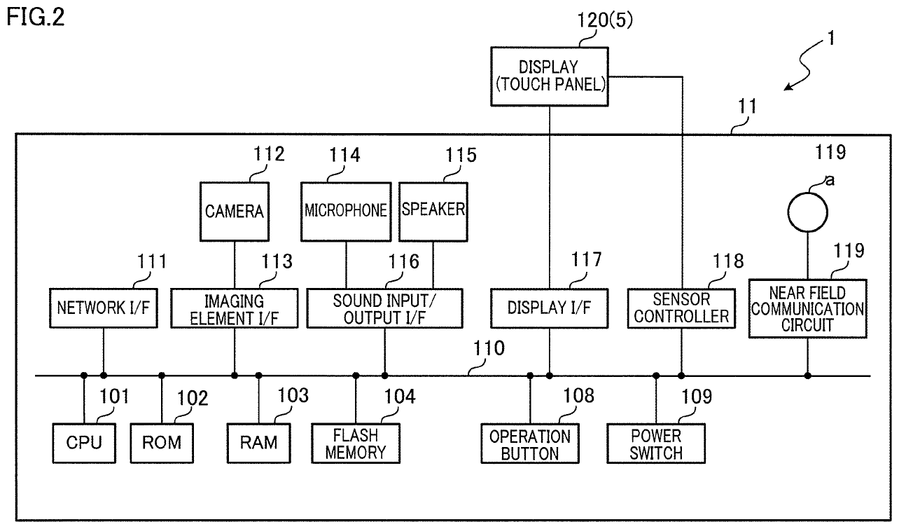

The slot game of the present embodiment is run as an online game. To be more specific, as shown in FIG. 2, the server 100 managed by an administration organization of the slot game is connected to smartphones 1 of many players over a computer network (Internet).

In this way, the slot game is run online. As a result of player's access to the web browser provided by the server 100 through an information device such as a smartphone 1 and a PC, the slot game can be run. The server 100 is configured to exchange credits (which can be bought by cash, a credit card, electronic money, a prepaid card, etc.) owned by players to coins (gaming media) which are electronic information usable in the slot game, and to manage the coins owned by the players.

### Structure of Server 100

As shown in FIG. 1, the server 100 is an information processor which is used by an administrator of the slot game, etc. to manage and control a social game service. As the server 100 receives a request from an information device such as a smartphone 1 operated by a player, the server 100 sends a game program, a web browser, etc. which can be run on the smartphone 1. The server 100 of the present embodiment includes a control unit 131, a storage unit 132, an input unit 133, a display unit 134, and a communication unit 135.

The control unit 131 (e.g., a CPU) is configured to control the server 100. Furthermore, data is sent and received between the control unit 131, the storage unit 132, the input unit 133, the display unit 134, and the communication unit 135. The storage unit 132 is constituted by a ROM (Read Only Memory) storing a system program, a RAM (Random Access Memory) which is a rewritable storage area, a flash memory, etc. The input unit 133 is a device allowing the administrator or the like to input setting or the like of the slot game, and is embodied by a keyboard and a mouse, for example. The display unit 134 is configured to display an operation screen for the administrator, in response to an instruction from the control unit 131. The communication unit 135 is provided to communicate with the smartphones 1.

### Structure of Smartphone 1

As shown in FIG. 2, the smartphone 1 includes, in a housing 11, a CPU 101 (controller), a ROM 102, a RAM 103, a flash memory 104, an operation button 108, a power switch 109, a bus line 110, a network I/F 111, a camera 112, an imaging element I/F 113, a microphone 114, a speaker 115, a sound input/output I/F 116, a display I/F 117, a sensor controller 118, a near field communication circuit 119, and an antenna 119a of the near field communication circuit 119. In the front surface of the housing 11, a display 120 with a touch panel 5 (input unit) is embedded.

The display 120 is configured to be able to display images. The display method of the display 120 is, for example, liquid crystal, organic electroluminescence, CRT (Cathode Ray Tube), and plasma.

The CPU (Central Processing Unit) 101 controls the entire smartphone 1. The ROM (Read Only Memory) 102 stores programs used for driving the CPU 101, such as an IPL (Initial Program Loader).

The RAM (Random Access Memory) 103 is used as a work area of the CPU 101. The flash memory 104 stores application software (program) for running the game of the present embodiment, a communication program, and data such as image data and sound data. The operation button 108 is used for, for example, initial setting of the smartphone 1. The power switch 109 is used for turning on/off the power source of the smartphone 1.

The network I/F (Interface) 111 is an interface for performing data communication with the server 100, etc., by utilizing a communication network such as the Internet. The camera 112 is a built-in camera image capturing means which captures an image of an object to obtain image data under the control of the CPU 101. The imaging element I/F 113 is a circuit for controlling the camera 112. The microphone 114 is a built-in sound collection means to which sound is input. The sound input/output I/F 116 is a circuit for processing input and output of a sound signal between the microphone 114 and the speaker 115 under the control of the CPU 101. The display I/F 117 is a circuit for sending image data to the display 120 under the control of the CPU 101. The sensor controller 118 is a circuit for receiving an input from the touch panel 5 of the display 120. The near field communication circuit 119 is a communication circuit based on NFC (Near Field Communication) (Registered Trademark). Bluetooth (Registered Trademark), or the like. The bus line 110 is an address bus, a data bus, or the like for electrically connecting the components such as the CPU 101.

### Outline of Slot Game Executed by Server 100

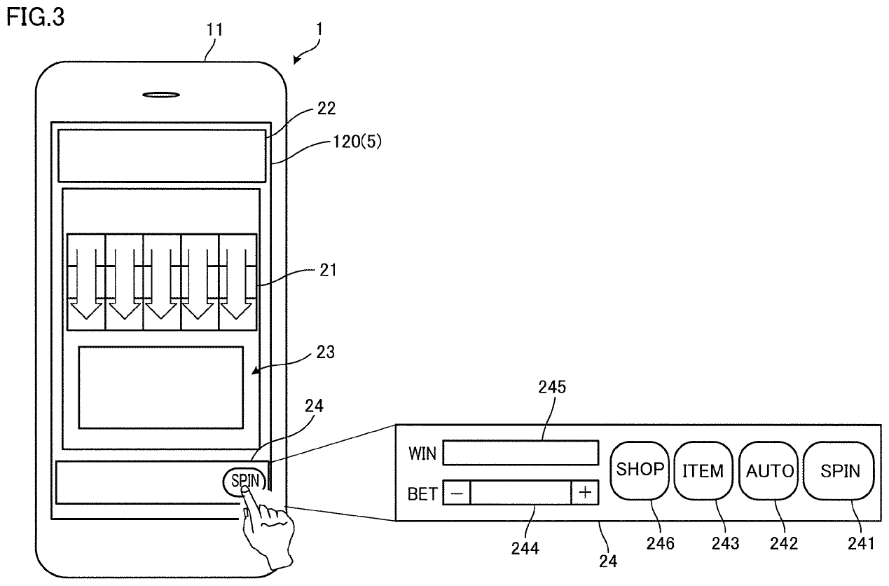

When a request is sent from the smartphone 1 to the server 100, effect images, videos, etc. of the slot game are displayed by a web browser on the display 120 of the smartphone 1. Thereafter, the slot game starts upon selection of a selection image indicating the start of the slot game on the touch panel 5 (detailed later). For example, as shown in FIG. 3, when the slot game starts, the slot game in which symbols are rearranged in a symbol display area 21 which is formed of 20 areas forming a matrix with 5 columns and 4 rows becomes executable.

Plural types of slot games may be executable, and the rule, the state of payout, and effect images may be different depending on which slot game is executed. For example, in a slot game of one type, symbols are rearranged in a symbol display area formed of 9 areas forming a matrix with 3 columns and 3 rows. In this slot game, whether a win is achieved is determined based on a combination of symbols rearranged on a payline set only at the middle stage of the symbol display area (winning determination).

The slot game of the present embodiment is basically started in response to the consumption of a predetermined amount of coins (gaming media) owned by a player. When a predetermined condition is established (e.g., when a condition of awarding a free game is satisfied or for a predetermined number of times per day), the slot game can be started without the consumption of coins.

The coins (gaming media) owned by players are electronic information. A player accesses the server 100 via the smartphone 1 and exchanges credits to coins in accordance with a payment method specified by the management organization of the slot game. The coins owned by players are used in various ways. For example, the coins are consumed to obtain an effect influencing on the slot game (as purchase of items), or consumed to change the appearance of an avatar of a player.

The number of coins owned by each player, which is managed by the server 100, is shared between the server 100 and each smartphone 1.

The gaming medium is not limited to any particular type, and may be electronic money or a game point not including valuable information.

### Slot Game: Definitions

The slot game executed in the present embodiment is, as shown in FIG. 3, a game in which symbols are varied in the symbol display area 21 (scrolling image of reels) and then stopped (rearranged), and a benefit (e.g., a payout or an item advantageous or disadvantageous for the player) is awarded based on the combination of the symbols displayed in the symbol display area 21. A state in which symbols are displayed after being varied and stopped in the symbol display area 21 is termed “rearrangement”.

A payout awarded based on a combination of symbols displayed in the symbol display area 21 is awarding of coins.

The “unit game” is a series of operations from the start of the receiving of a bet to the establishment of a prize (i.e., a combination of symbols satisfies a predetermined relation). To put it differently, the unit game includes a single bet time for receiving a bet, a single game time of rearranging stopped symbols, and a single payout time of a payout process of awarding a payout.

### Slot Game Screen

A slot game screen displayed on the display 120 of the smartphone 1 will be described.

As shown in FIG. 3, when the slot game is executed, the slot game screen is displayed on the display 120. The slot game screen displays the symbol display area 21 formed of 20 areas forming a matrix with 5 columns and 4 rows, a game information display area 22 on which information of increment and decrement in accordance with the execution of the slot game (e.g., the number of currently-owned coins) is displayed, an effect display area 23 on which moving and still images and messages related to the game are displayed in accordance with the progress of the slot game, and an operation display area 24 which is operated by the player to progress the slot game. The operation display area 24 includes a spin button 241, an AUTO button 242, an ITEM button 243, a bet button 244, a WIN display portion 245, and a shop button 246.

On the entire surface of the display 120, a touch panel 5 which allows the slot game screen to be viewable from the outside is provided. The touch panel 5 makes it possible to detect the coordinates of a part touched by a player's finger or the like. With this arrangement, for example, the slot game (unit game) is executed once, upon a touch input of the image of the spin button 241. Furthermore, the slot game is serially executed plural times as the image of the AUTO button 242 is pressed. When the image of the ITEM button 243 is pressed, the player is able to select and use a previously-obtained item (which exerts an influence in the slot game). When the image of the shop button 246 is touched, the smartphone 1 accesses the server 100 and the player enters a shop in which credits (which can be bought by cash, a credit card, electronic money, a prepaid card, etc. owned by the player) are exchangeable with coins, or credits or coins are exchangeable with an item.

### Paylines

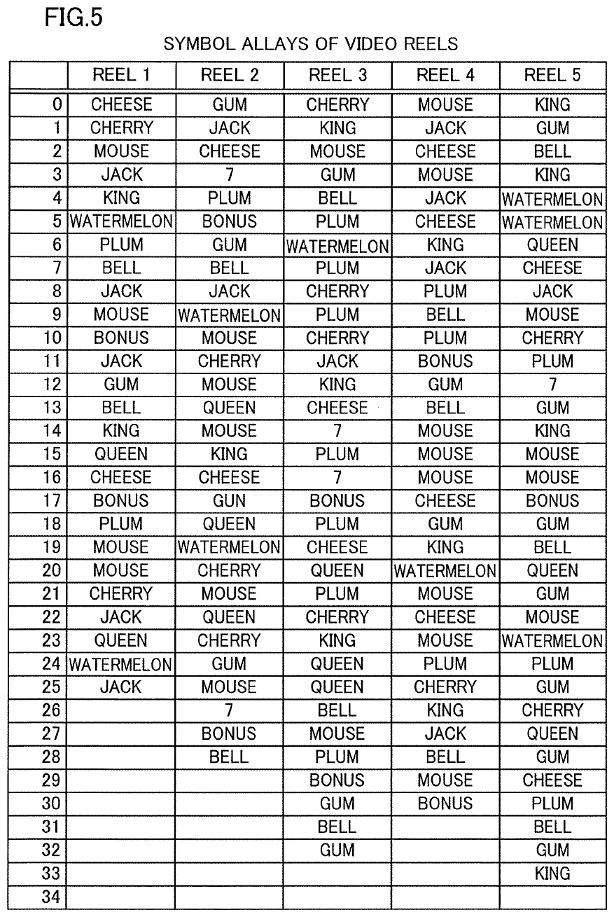

In the symbol display area 21, five video reels on which symbols are provided (see FIG. 5) are scrolled, and are stopped after a predetermined time elapses. As a result, parts of each video reel (four successive symbols in the present embodiment) are displayed for the player. In the symbol display area 21, one symbol is displayed in each of the areas in the upper stage, the upper middle stage, the lower middle stage, and the lower stage, in each video reel. To put it differently, 20 symbols forming a matrix with 5 columns and 4 rows are displayed in the symbol display area 21.

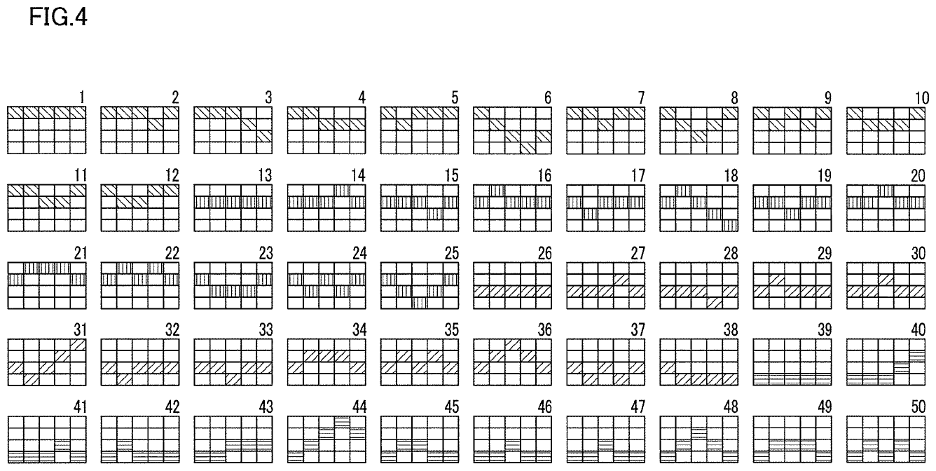

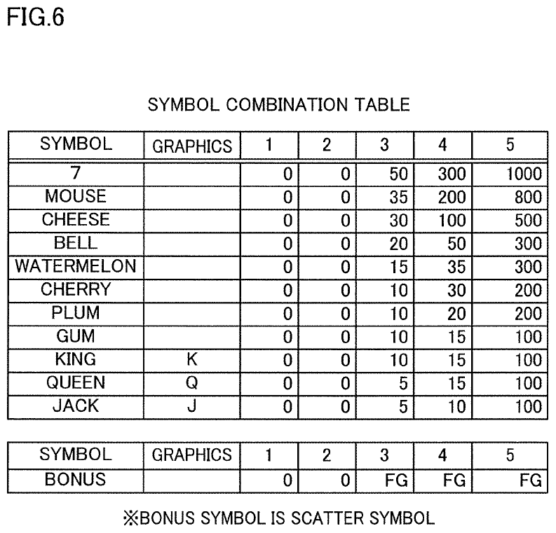

In the present embodiment, one of four stages, i.e., the upper stage, the upper middle stage, the lower middle stage, and the lower stage, is selected in each of the video reels, and a line connecting the selected stages is used as a payline (see FIG. 4). When three or more symbols of the same type successively stop on the payline, a win is achieved (a payout is awarded) (see FIG. 6). In regard to the number of the paylines, while there are 50 paylines in the present embodiment as shown in FIG. 5, the number of the paylines may be 30, for example.

### Symbol Columns of Video Reels

Now, with reference to FIG. 5, the following describes a configuration of the symbol arrays on the video reels of the slot game.

As shown in FIG. 5, to each of “REEL1”, “REEL2”, “REEL3”, “REEL4”, and “REEL5” of the video reels, a symbol array formed of symbols corresponding to code numbers 0 to 33 is allocated. The types of the symbols in each symbol array of the video reel 3 include normal symbols “7”, “MOUSE”, “CHEESE”, “BELL”, “WATERMELON” “CHERRY”, “PLUM”, “GUM”, “KING (K)”, “QUEEN (Q)”, and “JACK (J)”, and a “BONUS” symbol constituting a win of BONUS which is a trigger of awarding of a free game. The “BONUS” symbol is a scatter symbol, and whether a win is achieved is determined by the number of symbols stopped in 20 regions forming the matrix of 5 columns and 4 rows in the symbol display area 21.

### Symbol Combination Table

Now, a symbol combination table will be described with reference to FIG. 6. FIG. 6 shows a symbol combination table used in the slot game of the present embodiment.

The symbol combination table of the slot game defines the combinations of symbols (the number of symbols) with which a win is achieved and payout amounts of coins paid out (payout). In the slot game, scroll of five video reels is stopped, and a win is achieved when three or more symbols of the same type successively stop on a payline which is a target of result determination, in the symbol display area 21 (see FIG. 6). In accordance with the type of win, a benefit will be given to the player in the form of awarding a payout and the like.

### Contents of Program

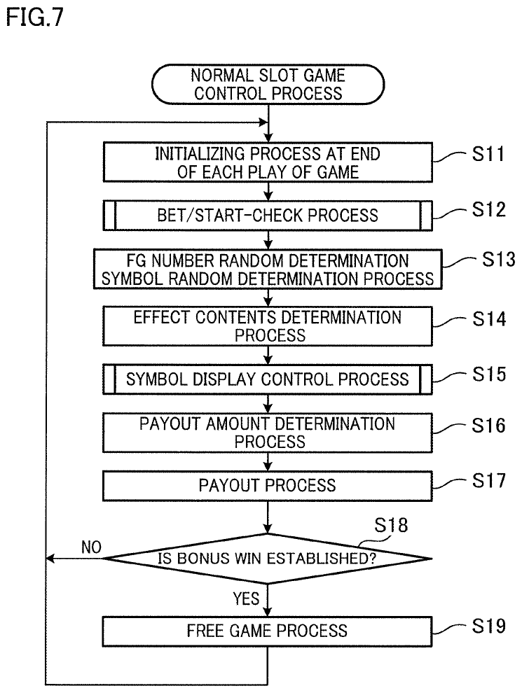

Now, the program of the slot game executed by the server 100 will be described with reference to FIG. 7 to FIG. 11.

### Normal Slot Game Control Process

Referring to FIG. 7, a normal slot game control process will be described. In the descriptions below, processes are executed as a result of sending and receiving of requests and information between the smartphone 1 operated by the player and the server 100, and results of the processes are displayed on the display 120 of the smartphone 1.

To begin with, the control unit 131 executes an initializing process at the end of each play of the game, in order to start the slot game (S11). For example, this process clears data in a working area of the storage unit 132, which becomes unnecessary at the end of each play of the unit game, e.g., a payline activated in the previous execution of the unit game, the value of a bet counter in a bet amount storage area, and symbols to be displayed on the symbol display area 21 as a result of random determination.

The control unit 131 then executes a later-described bet/start-check process (S12). In this process, for example, an input such as pressing of a “+” button and a “−” button (see FIG. 3) of the bet button 244 of the operation display area 24 of the display 120 of the smartphone 1 through the touch panel 5 is checked. As a result of this, the value of the bet counter of the storage unit 132 is determined. In other words, the number of coins betted on the unit game by the player is determined.

Next, the control unit 131 executes a FG number random determination symbol random determination process (S13). In this process, to begin with, the number of times of execution of the free game, which corresponds to a BONUS symbol arranged on the video reels, is randomly determined to be 5, 10, or 15. For example, when the number of times is 10, a text “10” is added to the BONUS symbol on the video reels.

Subsequently, by using the video reels shown in FIG. 5, to-be-stopped symbols are randomly selected from symbols provided on the video reels (REEL1, REEL2, REEL3, REEL4, and REEL5). The to-be-stopped symbols are data of five symbols to be displayed in the lower middle stage of each column of the symbol display area 21, out of the symbols forming each video reel. In this way, 20 symbols displayed in the symbol display area 21 are determined.

For example, in case of REEL1 of the video reels, when a code number “22” is randomly selected from 26 symbols (code numbers “0” to “25”), the “JACK” symbol corresponding to the code number “22” is selected as the to-be-stopped symbol. In case of the REEL2, when a code number “3” is randomly selected from 29 symbols (code numbers “0” to “28”), the “7” symbol corresponding to the code number “3” is selected as the to-be-stopped symbol. In case of the REEL3, when a code number “30” is randomly selected from 33 symbols (code numbers “0” to “32”), the “GUM” symbol corresponding to the code number “30” is selected as the to-be-stopped symbol. In case of the REEL4, when a code number “18” is randomly selected from 31 symbols (code numbers “0” to “30”), the “GUM” symbol corresponding to the code number “18” is selected as the to-be-stopped symbol. In case of the REEL5, when a code number “13” is randomly selected from 34 symbols (code numbers “0” to “33”), the “GUM” symbol corresponding to the code number “13” is selected as the to-be-stopped symbol.

The control unit 131 stores the determined five to-be-stopped symbols in a symbol storing area in the storage unit 132.

Subsequently, the control unit 131 executes an effect contents determination process (S14). The control unit 131 samples an effect-use random number and randomly selects any of a plurality of predetermined effect contents.

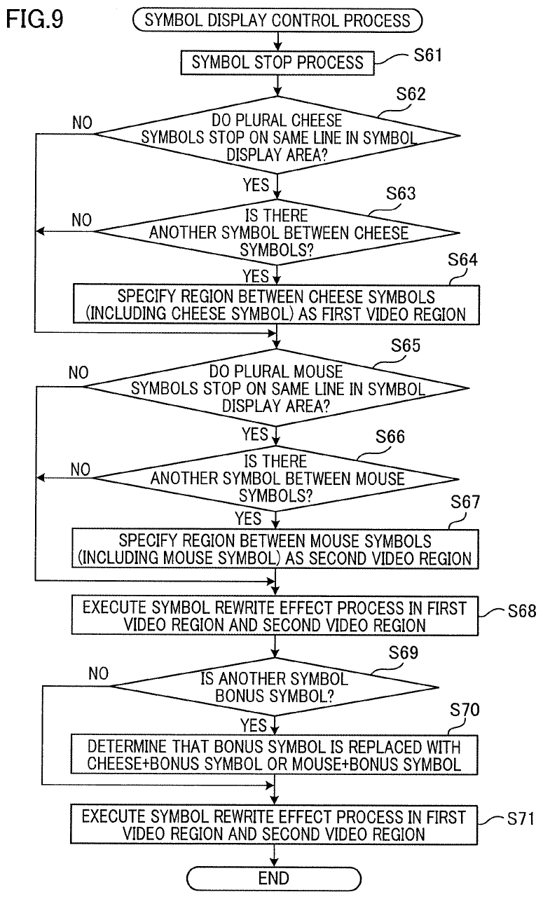

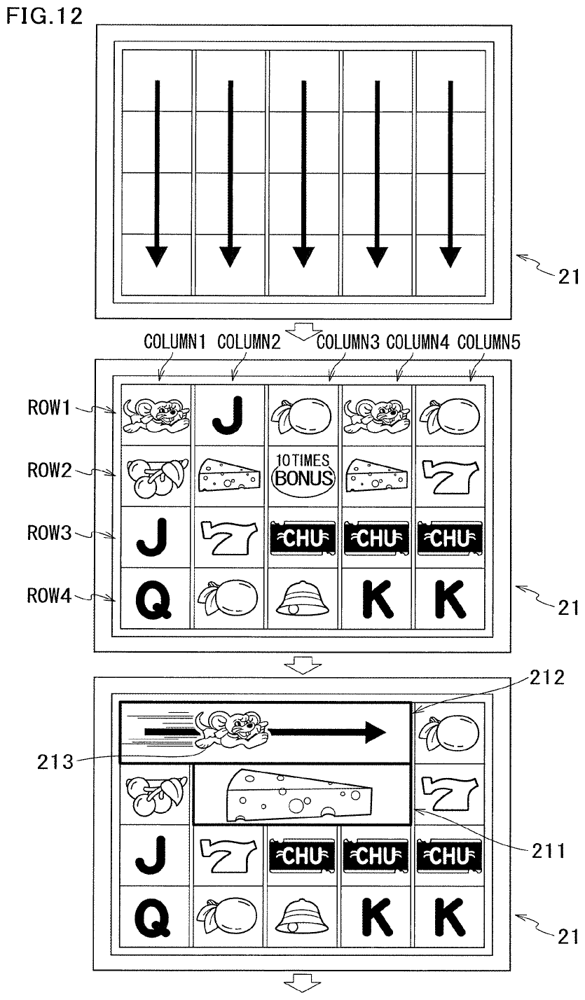

Then, the control unit 131 executes a symbol display control process (S15). In this symbol display control process, to begin with, the control unit 131 executes a symbol stop process as shown in FIG. 9 (S61). In the symbol stop process, five video reels are scrolled in the symbol display area 21 of the smartphone 1. After a predetermined time elapses, the five to-be-stopped symbols determined in the symbol random determination process in S13 are stopped one by one in the lower middle stage of each column of the symbol display area 21. That is, 20 symbols including the to-be-stopped symbols are displayed in the symbol display area 21. For example, as described above, when the “JACK” symbol is selected as a to-be-stopped symbol in the REEL1, the “7” symbol is selected as a to-be-stopped symbol in the REEL2, the “GUM” symbol is selected as a to-be-stopped symbol in the REEL3, the “GUM” symbol is selected as a to-be-stopped symbol in the REEL4, and the “GUM” symbol is selected as a to-be-stopped symbol in the REEL5, the symbols “JACK”, “7”, “GUM”, “GUM”, and “GUM” are provided in the lower middle stages of the columns of the symbol display area 21, as shown in FIG. 12. In each column of the symbol display area 21, symbols having code numbers each of which is one number off the to-be-stopped symbols are rearranged (see FIG. 12).

Subsequently, the control unit 131 determines whether plural “CHEESE” symbols stop on the same line in the symbol display area 21 in which 20 symbols have stopped (S62). When plural “CHEESE” symbols stop on the same line in the symbol display area 21 (YES in S62), whether a symbol which is not the “CHEESE” symbol has stopped between the “CHEESE” symbols on the same line in the symbol display area 21 is determined (S63).

When a symbol which is not the “CHEESE” symbol has stopped between the “CHEESE” symbols (YES in S63), a region (including the “CHEESE” symbol) between the “CHEESE” symbols is specified as a first video region 211 (S64). In this first video region 211, an image regarding “CHEESE” is integrally displayed in a subsequent process.

For example, as shown in FIG. 12, when the “CHEESE” symbol stops at the intersection of row 2 and column 2 and the “CHEESE” symbol stops at the intersection of row 2 and column 4, there is a “BONUS” symbol different from the “CHEESE” symbol at the intersection of row 2 and column 3 between the “CHEESE” symbols. As a result, in the symbol display area 21, the region at the intersection of row 2 and column 2 where the “CHEESE” symbol has stopped, the region at the intersection of row 2 and column 3 where the “BONUS” symbol has stopped, and the region at the intersection of row 2 and column 4 where the “CHEESE” symbol has stopped are specified as a first video region 211.

After S64, when it is determined in S62 that plural “CHEESE” symbols do not stop on the same line in the symbol display area 21 (NO in S62) or when a symbol different from the “CHEESE” symbol does not stop between the “CHEESE” symbols in S63 (NO in S63), the control unit 131 determines whether plural “MOUSE” symbols stop on the same line in the symbol display area 21 in which 20 symbols have stopped (S65). When plural “MOUSE” symbols stop on the same line in the symbol display area 21 (YES in S65), whether a symbol which is not the “MOUSE” symbol has stopped between the “MOUSE” symbols on the same line in the symbol display area 21 is determined (S66).

When a symbol which is not the “MOUSE” symbol has stopped between the “MOUSE” symbols (YES in S66), a region (including the “MOUSE” symbol) between the “MOUSE” symbols is specified as a second video region 212 (S67). In this second video region 212, an image regarding “MOUSE” is integrally displayed in a subsequent process.

For example, when the “MOUSE” symbol stops at the intersection of row 1 and column 1 and the “MOUSE” symbol stops at the intersection of row 1 and column 4 as shown in FIG. 12, there are a “JACK” symbol and a “PLUM” symbol different from the “MOUSE” symbol at the intersection of row 1 and column 2 and the intersection of row 1 and column 3 which are between the “MOUSE” symbols. As a result, in the symbol display area 21, the region at the intersection of row 1 and column 1 where the “MOUSE” symbol has stopped, the region at the intersection of row 1 and column 2 where the “JACK” symbol has stopped, the region at the intersection of row 1 and column 3 where the “PLUM” symbol has stopped, and the region at the intersection of row 1 and column 4 where the “MOUSE” symbol has stopped are specified as a second video region 212.

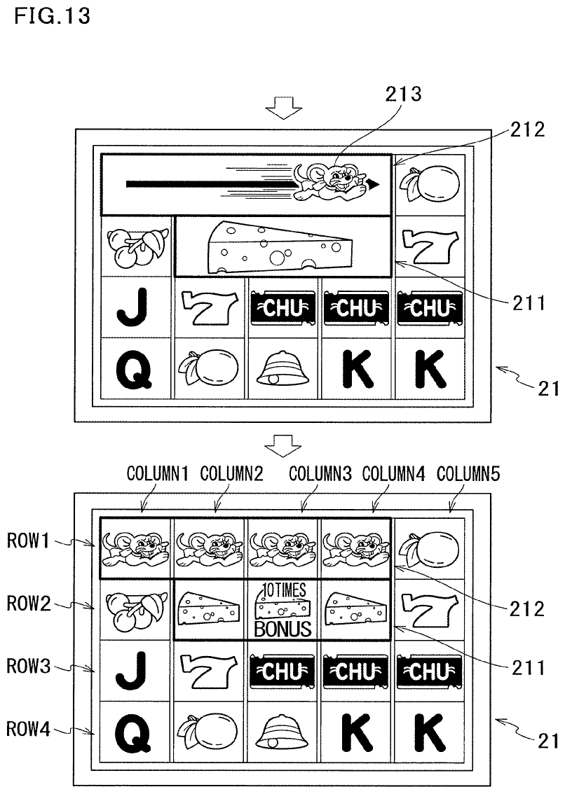

After S67, when it is determined in S65 that plural “MOUSE” symbols do not stop on the same line in the symbol display area 21 (NO in S65) or when a symbol different from the “MOUSE” symbol does not stop between the “MOUSE” symbols in S66 (NO in S66), the control unit 131 executes a symbol rewrite effect process in the first video region 211 and the second video region 212 which have been specified (S68). In this symbol rewrite effect process, in the first video region 211, an image of a piece of cheese is displayed in a flickering manner to fully occupy the inside of the frame of the first video region 211 (see FIG. 12 and FIG. 13). In the second video region 212, as shown in FIG. 12 and FIG. 13, image effect display is performed such that a mouse character 213 runs from the left end to the right end of the second video region 212.

Subsequently, in S63, whether another symbol having stopped between the “CHEESE” symbols is the “BONUS” symbol is determined (S69). Similarly, in S66, whether another symbol having stopped between the “MOUSE” symbols is the “BONUS” symbol is determined. When the another symbol is the “BONUS” symbol (YES in S69), because the “BONUS” symbol has stopped between the “CHEESE” symbols, the “BONUS” symbol is replaced with a “CHEESE+BONUS” symbol which exerts the effects of both the “BONUS” symbol and the “CHEESE” symbol (S70). Furthermore, when the another symbol between the “MOUSE” symbols is the “BONUS” symbol, the “MOUSE” symbol is replaced with a “MOUSE+BONUS” symbol which exerts the effects of both the “BONUS” symbol and the “MOUSE” symbol (S70).

After S70 or when the another symbol is not the “BONUS” symbol in S69 (NO in S69), the control unit 131 execute a symbol rewrite process in the first video region 211 and the second video region 212 having been specified (S71). In this symbol rewrite process, in the first video region 211, an image effect is performed such that a symbol having stopped in each of the regions constituting the first video region 211 is replaced with the “CHEESE” symbol. For example, when, as shown in FIG. 12, the “CHEESE” symbol stops at the intersection of row 2 and column 2, the “BONUS” symbol stops at the intersection of row 2 and column 3, and the “CHEESE” symbol stops at the intersection of row 2 and column 4 in the symbol display area 21 and the regions where these symbols stop are specified as the first video region 211, the symbol display area 21 is rewritten to a state in which the “CHEESE” symbol stops at the intersection of row 2 and column 2, the “CHEESE+BONUS” symbol stops at the intersection of row 2 and column 3, and the “CHEESE” symbol stops at the intersection of row 2 and column 4, as shown in FIG. 13. At this stage, the “CHEESE” symbols (including the “CHEESE+BONUS” symbol) are highlighted by changing the brightness of the symbol display area 21.

In addition to the above, in the second video region 212, an image effect is performed such that a symbol having stopped in each of the regions constituting the second video region 212 is replaced with the “MOUSE” symbol (equivalent to a specific symbol). For example, when, as shown in FIG. 12, when the “MOUSE” symbol stops at the intersection of the row 1 and column 1, the “JACK” symbol stops at the intersection of row 1 and column 2, the “PLUM” symbol stops at the intersection of row 1 and column 3, and the “MOUSE” symbol stops at the intersection of row 1 and column 4 in the symbol display area 21 and the regions where these symbols stop are specified as the second video region 212, the symbol display area 21 is rewritten to a state in which the “MOUSE” symbol stops at the intersection of row 1 and column 1, the “MOUSE” symbol stops at the intersection of row 1 and column 2, the “MOUSE” symbol stops at the intersection of row 1 and column 3, and the “MOUSE” symbol stops at the intersection of row 1 and column 4, as shown in FIG. 13. At this stage, the “MOUSE” symbols (including the “MOUSE+BONUS” symbol) are highlighted by changing the brightness of the symbol display area 21.

As described above, after symbols arranged on the video reels are stopped in the symbol display area 21, only the “CHEESE” symbols (“MOUSE” symbols) and another symbol sandwiched between the “CHEESE” symbols (“MOUSE” symbols) are replaced with the “CHEESE” symbols (“MOUSE” symbols). It is therefore unnecessary in advance to prepare another video reel on which a larger number of “CHEESE” symbols (“MOUSE” symbols) are provided, and it is unnecessary to perform a process of increasing the number of “CHEESE” symbols (“MOUSE” symbols) while the video reels are scrolling. On this account, an effect of increasing the “CHEESE” symbols (“MOUSE” symbols) can be executed without increasing the required capacity of the storage device 132, while the system of processes is less likely to become complicated.

In the arrangement above, after symbols arranged on the video reels are stopped in the symbol display area 21, the “CHEESE” symbols and the region between the “CHEESE” symbols are specified as the first video region 211 which is a video region where an image effect is possible. In the first video region 211, an image effect is performed such that another symbol between the “CHEESE” symbols is replaced with the “CHEESE” symbol, and the “CHEESE” symbols are highlighted by changing the brightness of the symbol display area 21. As such, it is emphasized that only the another symbol sandwiched between the “CHEESE” symbols is replaced with the “CHEESE” symbol. The same applies to an image effect on the second video region 212.

Subsequently, the control unit 131 executes a payout amount determination process (S16). In this process, whether three or more symbols of the same type successively stop on a payline of the symbol display area 21 and a win is achieved is determined based on the symbol combination table for the slot game (see FIG. 6), which is stored in the storage unit 132. In accordance with the type of win, a benefit will be given in the form of awarding a payout and the like. The payout awarded is stored in a payout amount storage area of the storage unit 132.

For example, when, as shown in FIG. 13, the “MOUSE” symbol stops at the intersection of row 1 and column 1, the “MOUSE” symbol stops at the intersection of row 1 and column 2, the “MOUSE” symbol stops at the intersection of row 1 and column 3, and the “MOUSE” symbol stops at the intersection of row 1 and column 4 on a payline 1 (see FIG. 4), a win of 4 Kinds of “MOUSE” is achieved. For the 4 Kinds of “MOUSE”, the symbol combination table shown in FIG. 6 is referred to, and a payout is determined as “200” coins (when the bet amount is 1) and this payout amount is stored in the payout amount storage area in the storage unit 132.

Then the control unit 131 executes a payout process (S17). The control unit 131 adds a value stored in the payout amount storage area of the storage unit 132 to a value of the coin counter provided in the storage unit 132. For example, when “200” is stored in the payout amount storage area in the payout amount determination process in S16, “200” is added to the value of the coin counter.

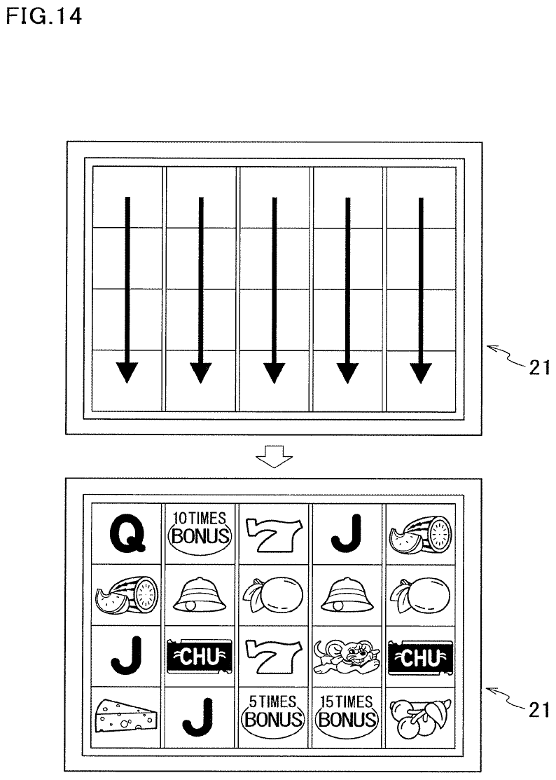

Subsequently, the control unit 131 determines whether a win with “BONUS” (3 Kinds of “BONUS”, 4 Kind of “BONUS”, or 5 Kind of “BONUS”) is achieved (S18). When the “BONUS” win is achieved (YES in S18), the control unit 131 executes a free game process (S19). This free game process allows the player to play the slot game without the consumption of coins, for the number of times of execution of the free game corresponding to the “BONUS” symbols having stopped in the symbol display area 21. For example, when, as shown in FIG. 14, the “BONUS (10 times)” symbol stops at the intersection of row 1 and column 2, the “BONUS (5 times)” symbol stops at the intersection of row 4 and column 3, and the “BONUS (15 times)” symbol stops at the intersection of row 4 and column 4 in the symbol display area 21 and 3 Kinds of “BONUS” is achieved, it is possible to execute the free game 30 times in total. The number of times of execution of the free game corresponding to each “BONUS” symbol is randomly determined in the above-described step S13.

If the “BONUS” win is not achieved (NO in S18) or after S19, the routine proceeds to S11.

### Bet/Start-Check Process

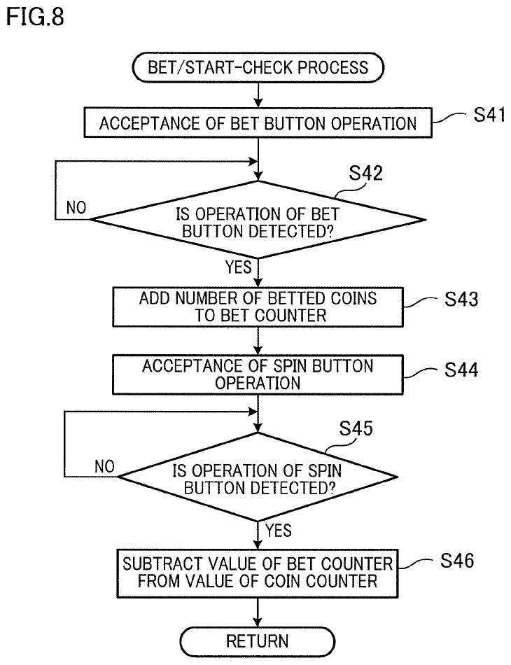

Now, the bet/start-check process will be described with reference to FIG. 8.

To begin with, the control unit 131 permits acceptance of a bet button operation by pressing the “+” or “−” button (see FIG. 3) of the bet button 244 of the operation display area 24 through the touch panel 5 (S41). As the number of coins betted on a unit game is selected, a payout of that unit game is calculated by multiplying the number of coins by a payout shown in FIG. 6.

Subsequently, the control unit 131 determines whether the bet button 244 is operated (pressed) (S42). When an operation of the bet button 244 is not detected (NO in S42), an operation is waited for.

Meanwhile, when an operation of the bet button 244 is detected (YES in S42), the control unit 131 adds the number of betted coins to the value of the bet counter in the storage unit 132 (S43).

Subsequently, after S43, the control unit 131 allows the spin button 241 to accept an operation (S44).

After S44, the control unit 131 determines whether or not an operation of the spin button 241 is detected (S45). When the control unit 131 determines that an operation of the spin button 241 is not detected (NO in S45), an operation of the spin button 241 is waited for.

Meanwhile, when the control unit 131 determines that an operation of the spin button 241 is detected (YES in S45), the control unit 131 subtracts the value of the bet counter calculated in S43 from the value of the coin counter in the storage unit 132 (S46). Then the bet/start check process is terminated.

### Free Game Process

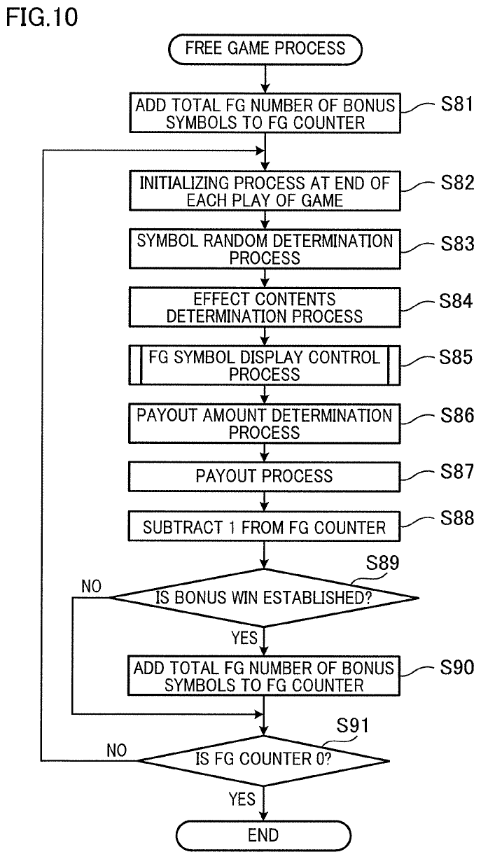

The following describes a free game process with reference to FIG. 10.

To begin with, when a “BONUS” win is achieved in S18 of the normal slot game control process, the control unit 131 adds the total number of times of execution of the free game corresponding to the “BONUS” symbols having stopped in the symbol display area 21 to an FG counter of the storage unit 132 (S81). For example, when, as shown in FIG. 14, the “BONUS (10 times)” symbol stops at the intersection of row 1 and column 2, the “BONUS (5 times)” symbol stops at the intersection of row 4 and column 3, and the “BONUS (15 times)” symbol stops at the intersection of row 4 and column 4 in the symbol display area 21 and 3 Kinds of “BONUS” is achieved, 30 which is the total number of times of execution of the free game is added to the FG counter.

Subsequently, the control unit 131 executes an initializing process at the end of each play of the game, in order to start the slot game in the free game (S82). For example, this process clears data in a working area of the storage unit 132, which becomes unnecessary at the end of each play of the unit game, e.g., symbols to be displayed on the symbol display area 21 as a result of random determination in the previous unit game. The value of the bet counter of the storage unit 132 is identical with the value in the normal slot game control process.

Then, the control unit 131 executes a symbol random determination process (S83). In this process, to begin with, the number of times of execution of the free game, which corresponds to a BONUS symbol arranged on the video reels, is randomly determined to be 5, 10, or 15. For example, when the number of times is 10, a text “10” is added to the BONUS symbol on the video reels.

Subsequently, by using the video reels shown in FIG. 5, to-be-stopped symbols are randomly selected from symbols provided on the video reels (REEL1, REEL2, REEL3, REEL4, and REEL5). The to-be-stopped symbols are data for five symbols to be displayed in the lower middle stage of each column of the symbol display area 21, out of the symbols forming each video reel. In this way, 20 symbols displayed in the symbol display area 21 are determined.

The control unit 131 stores the determined five to-be-stopped symbols in a symbol storing area in the storage unit 132.

Subsequently, the control unit 131 executes an effect contents determination process (S84). The control unit 131 samples an effect-use random number and randomly determines any of a plurality of predetermined effect contents.

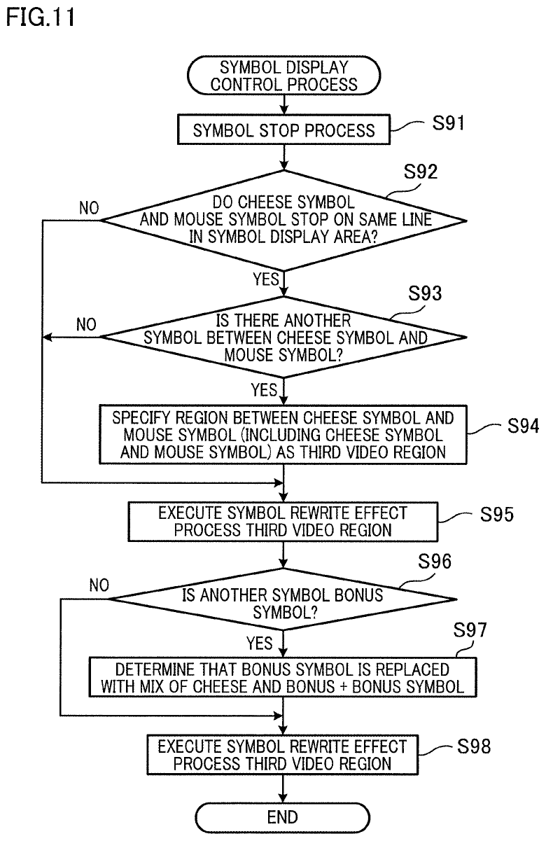

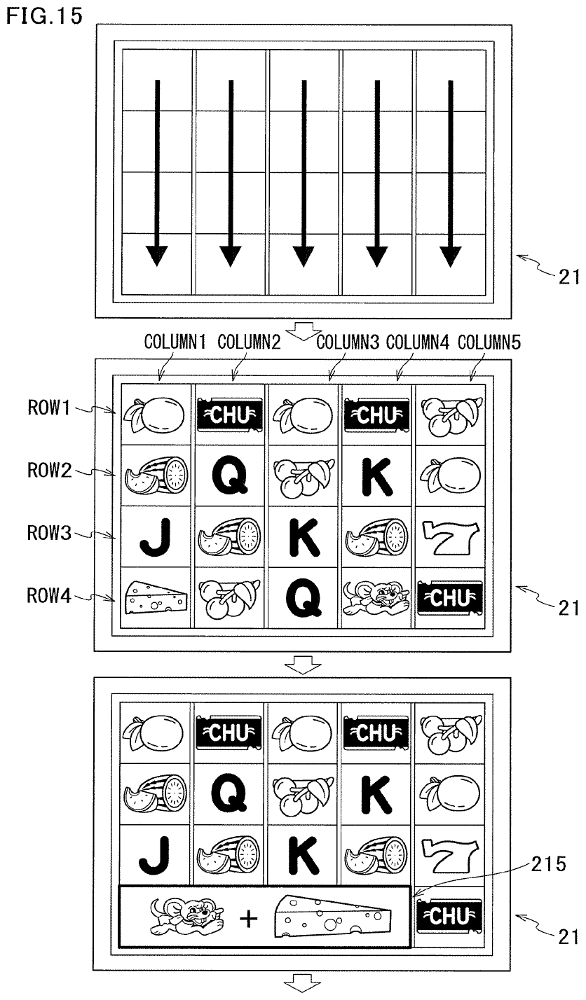

Then, the control unit 131 executes a FG symbol display control process (S85). In this FG symbol display control process, to begin with, the control unit 131 executes a symbol stop process as shown in FIG. 11 (S91). In the symbol stop process, five video reels are scrolled in the symbol display area 21 o the smartphone 1. After a predetermined time elapses, the five to-be-stopped symbols determined in the symbol random determination process in S83 are stopped one by one in the lower middle stage of each column of the symbol display area 21. That is, 20 symbols including the to-be-stopped symbols are displayed in the symbol display area 21. For example, as described above, when the “JACK” symbol is selected as a to-be-stopped symbol in the REEL1, the “WATERMELON” symbol is selected as a to-be-stopped symbol in the REEL2, the “KING” symbol is selected as a to-be-stopped symbol in the REEL3, the “WATERMELON” symbol is selected as a to-be-stopped symbol in the REEL4, and the “7” symbol is selected as a to-be-stopped symbol in the REEL5, the symbols are provided in the symbol display area 21, as shown in FIG. 15.

Subsequently, the control unit 131 determines whether a “CHEESE” symbol and a “MOUSE” symbol stop on the same line in the symbol display area 21 in which 20 symbols have stopped (S92). When the “CHEESE” symbol and the “MOUSE” symbol stop on the same line in the symbol display area 21 (YES in S92), whether another symbol which is neither the “CHEESE” symbol nor the “MOUSE” symbol has stopped between the “CHEESE” symbol and the “MOUSE” symbol having stopped on the same line in the symbol display area 21 is determined (S93).

When another symbol which is neither the “CHEESE” symbol nor the “MOUSE” symbol stops between the “CHEESE” symbol and the “MOUSE” symbol (YES in S93), a region (including the “CHEESE” symbol and the “MOUSE” symbol) between the “CHEESE” symbol and the “MOUSE” symbol is specified as a third video region 215 (S94). In this third video region 215, an image regarding “CHEESE” and “MOUSE” is integrally displayed in a subsequent process.

For example, when the “CHEESE” symbol stops at the intersection of row 4 and column 1 and the “MOUSE” symbol stops at the intersection of row 4 and column 4 as shown in FIG. 15, there are a “CHERRY” symbol and a “QUEEN” symbol at the intersection of row 4 and column 2 and the intersection of row 4 and column 3 which are between the “CHEESE” symbol and the “MOUSE” symbol. As a result, in the symbol display area 21, the region at the intersection of row 4 and column 1 where the “CHEESE” symbol has stopped, the region at the intersection of row 4 and column 2 where the “CHERRY” symbol has stopped, the region at the intersection of row 4 and column 3 where the “QUEEN” symbol has stopped, and the region at the intersection of row 4 and column 4 where the “MOUSE” symbol has stopped are specified as a third video region 215.

After S94, when it is determined in S92 that plural “CHEESE” symbol and “MOUSE” symbol do not stop on the same line in the symbol display area 21 (NO in S92) or when another symbol which is neither the “CHEESE” symbol nor the “MOUSE” symbol does not stop between the “CHEESE” symbol and the “MOUSE” symbol in S93 (NO in S93), the control unit 131 executes a symbol rewrite effect process in the third video region 215 which has been specified (S95). In this symbol rewrite effect process, in the third video region 215, an image of a mouse chasing a piece of cheese is displayed (see FIG. 15).

Subsequently, in S93, whether the symbol having stopped between the “CHEESE” symbol and the “MOUSE” symbol is the “BONUS” symbol is determined (S96). When the another symbol is the “BONUS” symbol (YES in S96), the “BONUS” symbol is replaced with a “MIX+BONUS” symbol which exerts the effects of both the “BONUS” symbol and the “MIX” symbol of the “CHEESE” and “MOUSE” (S97).

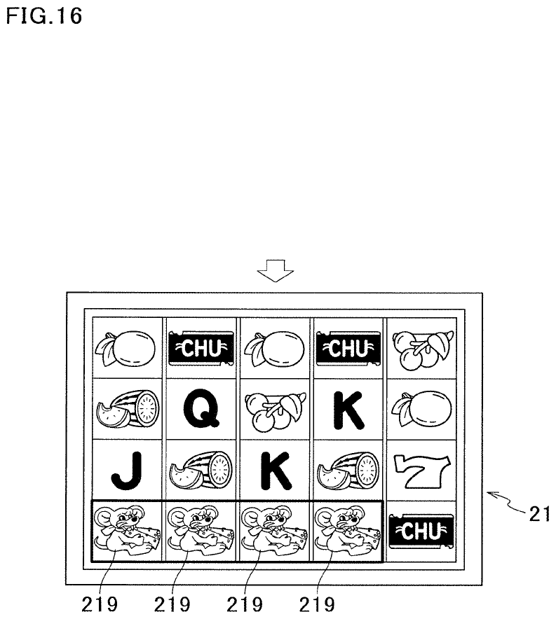

After S97 or when the another symbol is not the “BONUS” symbol in S96 (NO in S96), the control unit 131 execute a symbol rewrite process in the third video region 215 having been specified (S98). In this symbol rewrite process, an image effect is performed in the third video region 215 such that a symbol having stopped in each of the regions constituting the third video region 215 is replaced with the “MIX” symbol 219 of “CHEESE” and “MOUSE”. For example, when, as shown in FIG. 15, when the “CHEESE” symbol stops at the intersection of the row 4 and column 1, the “CHERRY” symbol stops at the intersection of row 4 and column 2, the “QUEEN” symbol stops at the intersection of row 4 and column 3, and the “MOUSE” symbol stops at the intersection of row 4 and column 4 in the symbol display area 21 and the regions where these symbols stop are specified as the third video region 215, the symbol display area 21 is rewritten to a state in which the “MIX” symbol 219 of “CHEESE” and “MOUSE” stops at the intersection of row 4 and column 1, the “MIX” symbol 219 of “CHEESE” and “MOUSE” stops at the intersection of row 4 and column 2, the “MIX” symbol 219 of “CHEESE” and “MOUSE” stops at the intersection of row 4 and column 3, and the “MIX” symbol 219 of “CHEESE” and “MOUSE” stops at the intersection of row 4 and column 4, as shown in FIG. 16. At this stage, the “MIX” symbols 219 of “CHEESE” and “MOUSE” are highlighted by changing the brightness of the symbol display area 21.

When in S96 the another symbol is the “BONUS” symbol (YES in S96), the “BONUS” symbol is replaced with a “MIX+BONUS” symbol which exerts the effects of both the “BONUS” symbol and the “MIX” symbol 219 of the “CHEESE” and “MOUSE”.

Subsequently, the control unit 131 executes a payout amount determination process (S86). In this process, whether three or more symbols of the same type successively stop on a payline of the symbol display area 21 and a win is achieved is determined based on the symbol combination table for the slot game (see FIG. 6), which is stored in the storage unit 132. In accordance with the type of win, a benefit will be given in the form of awarding a payout and the like. The payout awarded is stored in a payout amount storage area of the storage unit 132.

For example, when, as shown in FIG. 16, the “MIX” symbol 219 stops at the intersection of row 4 and column 1, the “MIX” symbol 219 stops at the intersection of row 4 and column 2, the “MIX” symbol 219 stops at the intersection of row 4 and column 3, and the “MIX” symbol 219 stops at the intersection of row 4 and column 4 on a payline 39 (see FIG. 4), a win of 4 Kinds of “MIX” is achieved. For the 4 Kinds of “MIX”, a payout is determined as “300” coins (when the bet amount is 1) as a result of adding up of the payout of the win of 4 Kinds of “MOUSE” and the payout of the wing of 4 Kinds of “CHEESE”, and this payout amount is stored in the payout amount storage area in the storage unit 132.

Then the control unit 131 executes a payout process (S87). The control unit 131 adds a value stored in the payout amount storage area of the storage unit 132 to a value stored in the coin counter provided in the storage unit 132. For example, when “300” is stored in the payout amount storage area in the payout amount determination process in S86, “300” is added to the value of the coin counter.

The control unit 131 then subtracts 1 from the value of the FG counter in the storage unit 132 (S88).

Subsequently, the control unit 131 determines whether a win with “BONUS” (3 Kinds of “BONUS”, 4 Kind of “BONUS”, or 5 Kind of “BONUS”) is achieved (S89). When a “BONUS” win is achieved (YES in S89), the control unit 131 adds the total number of times of execution of the free game corresponding to the “BONUS” symbols having stopped in the symbol display area 21 to the FG counter of the storage unit 132 (S90).

If the “BONUS” win is not achieved (NO in S89) or after S90, the control unit 131 determines whether the value of the FG counter of the storage unit 132 is 0 (S91). When the value of the FG counter is not 0 (NO in S91), the routine proceeds to S82. When the value of the FG counter is 0 (YES in S91), the routine is terminated.

### Other Embodiments

While in the embodiment above the slot game is executed by the server 100, the disclosure is not limited to this arrangement. For example, the slot game may be, as game software (a program and game data), installed in and executed by an information processor. Examples of the information processor include mobile information devices such as a smartphone, a portable computer, a laptop computer, a note PC, a tablet PC, a handheld PC, and a PDA (Personal Data Assistant). The game software by which the slot game is executed is downloaded from a server or the like via communication means and stored in a storage device (e.g., a flash memory) in the mobile information device. The communication means may be an interactive communication passage such as the Internet and a cable TV, or may be one-way broadcasting.

The game software by which the slot game is executed may be stored in a recording medium such as a CD-ROM, a DVD-ROM, an MO (optical magnetic disc), and a flash memory, and may be read from the recording medium and installed in a storage device of a information processor such as the server 100 and the smartphone 1, according to need.

A control method corresponding to the embodiment above is as below.

A method of controlling a unit game in which reel strips on which symbols are arranged stop in a matrix-shaped symbol display area, the method comprising the steps of:
(a) randomly determining symbols which will stop in the symbol display area;
(b) scrolling the reel strips and then stopping the symbols determined in the step (a) in the symbol display area;
(c) when plural specific symbols are included in the symbols having stopped in the symbol display area, determining whether another symbol which is different from the specific symbol stops between the specific symbols; and
(d) when it is determined in the step (c) that the another symbol stops between the stopped specific symbols, replacing the another symbol with the specific symbol.

A recording medium corresponding to the embodiment above is as below.

A non-volatile recording medium storing a game program,

The game program causes an information processor, which runs a unit game in which reel strips on which symbols are arranged stop in a matrix-shaped symbol display area, to execute the processes of:
(a) randomly determining symbols which will stop in the symbol display area;
(b) scrolling the reel strips and then stopping the symbols determined in the process (a) in the symbol display area;
(c) when plural specific symbols are included in the symbols having stopped in the symbol display area, determining whether another symbol which is different from the specific symbol stops between the specific symbols; and
(d) when it is determined in the process (c) that the another symbol stops between the stopped specific symbols, replacing the another symbol with the specific symbol.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

What is claimed is:

1. An information processor running a unit game in which reel strips on which symbols are arranged stop in a matrix-shaped symbol display area,
the information processor comprising a controller which is programmed to execute the processes of:
(a) randomly determining the symbols which will stop in the symbol display area;
(b) scrolling the reel strips and then stopping the symbols determined in the process (a) in the symbol display area;
(c) when plural specific symbols are included in the symbols having stopped in the symbol display area, determining whether another symbol which is different from the specific symbol stops between the specific symbols; and
(d) when it is determined in the process (c) that the another symbol stops between the stopped specific symbols, replacing the another symbol with the specific symbol.

2. The information processor according to claim 1, wherein,
in the step (d), a region including the another symbol and two of the specific symbols sandwiching the another symbol is specified as a video region where an image effect is possible, the image effect of replacing the another symbol with the specific symbol is performed in the video region, and the specific symbols are highlighted by changing brightness of the symbol display area.
